(19) United States
(12) Patent Application Publication
(10) Pub. No.: US 2013/0153511 A1
(43) Pub. Date: Jun. 20, 2013

(54) PROCESS FOR DEWATERING OF OIL SAND TAILING MUDS

(71) Applicant: Shell Oil Company, Houston, TX (US)

(72) Inventors: Jozef Jacobus Titus SMITS, Amsterdam (NL); Johannes Leendert Willem Cornelis DEN BOESTERT, Amsterdam (NL); Jose Luis BRAVO, Houston, TX (US)

(73) Assignee: SHELL OIL COMPANY, Houston, TX (US)

(21) Appl. No.: 13/679,509

(22) Filed: Nov. 16, 2012

(30) Foreign Application Priority Data
Dec. 16, 2011 (EP) EP11194026.8

(51) Int. Cl. C02F 1/52

(52) U.S. Cl. CPC C02F 1/5227
USPC 210/731; 210/738; 210/735

(57) ABSTRACT

The present invention relates to a process for dewatering oil sand tailing muds, comprising: (a) adding a flocculant into oil sand tailing muds and mixing the flocculant and the tailing muds; (b) filtering the flocculated tailing muds using a dynamic filtration system, wherein in step (b) a pressure difference is applied over the filter and wherein the dynamic filtration system comprises a means for producing a dynamic action by which the filter cake is continuously or intermittently moved, deformed and/or broken, the filter cake being the solidified material that sets on the filter during filtration. The process is useful for dewatering oil sand tailing muds from tailing ponds, such as those produced in the Athabasca Oil Fields in Canada.

This application claims the benefit of European Patent Application No. 11194026.8, filed on Dec. 16, 2011, the disclosure of which is incorporated by reference herein in its entirety.

### TECHNICAL FIELD OF THE INVENTION

The present invention relates to a process for enhanced dewatering of oil sand tailing muds.

### BACKGROUND OF THE INVENTION

Oil sands are found in large amounts in many countries throughout the world, but in extremely large quantities in Canada and Venezuela. Such sands, also known as bituminous sands or tar sands, contain naturally occurring mixtures of sand, clay minerals, water, and a dense and extremely viscous form of petroleum, technically referred to as bitumen (or also “tar” due to its similar appearance, odour, and colour). Oil sands are mined via open-pit mining and hot water is used to extract the hydrocarbon content, the bitumen, from these oil sands and the clay minerals. After removal of the bitumen, the bitumen depleted slurry, generally containing various mixtures of coarse solids, sand, silt, clay, some residual bitumen and water, is generally considered as oil sands tailings. Because of the presence of fine clay minerals, the produced slurry generally is a suspension that settles slowly. Part of the water is recycled, but a substantial amount is fed into so-called tailing ponds, lakes of fine particles suspended in water, to further settle. The top layer of clarified water is recycled, and a dense mixture of sand, clay, silt, some residual bitumen and water remains (so-called tailing muds, Mature Fine Tailings, or MFTs). As the process consumes a lot of water—up to about 5 volume units of water to produce each volume unit of crude oil—very large tailing ponds have already been created.

MFTs behave as a fluid-like colloidal material, which significantly limits options to reclaim tailings ponds. Conventional, commercially applied dewatering treatments of MFT are very difficult. Various filtration technologies suffer from partial or complete blockage of the filter cloths in an early stage of the process. Also there is insufficient retention of the very fine filter particulates. Centrifugal separations are far too energy intensive. However, without dewatering or solidifying the MFTs, tailings ponds form an increasing environmental problem in the exploitation of oil sands. If MFTs can be sufficiently dewatered so as to convert the waste product into a reclaimed firm material, then many of the problems associated with this material can be appropriately solved. Otherwise, it may take tens of years before the tailings settle and the water from the tailing ponds clarifies.

In the last few years, new processes have been developed to recover the tailings, which processes accelerate the settling of fine clay, sand, water, and residual bitumen in the ponds after oil sands extraction. One technology involves dredging mature tailings from a pond bottom, mixing the suspension with a polymer flocculant, and spreading the sludge-like mixture as a deposit over a “beach” with a shallow grade. See e.g. WO 2011032258. The flocculation process herein is a process wherein colloids come out of the tailing water in the form of flocs or flakes as a result of the addition of a specific clarifying agent, the flocculant. It was claimed, that this process could reduce the time for recycling of clear water from tailings to weeks rather than years, with the recovered water being recycled into the oil sands plant. In addition to reducing the number of tailing ponds, the time to reclaim a tailing pond would be reduced significantly, e.g. from 40 years at present to 7-10 years.

Although with the process of WO 2011032258 the time for reclaiming the tailing ponds may be significantly reduced, it requires enormous surface areas, e.g. shallow “beaches” or deposition cells, and huge equipment for deposit formation, if applied commercially. Furthermore, dewatering by this way of drainage results in residual materials of around 60% of solids. This type of material is still a thin, clay-like substance.

It would be an improvement in the art to provide an energy-efficient process for dewatering tailing muds, especially oil sand tailings, e.g. Mature Fine Tailings, which would require compact equipment, i.e with a relatively “small” footprint, and which would, in addition, produce (semi-)solid materials and clear water.

According to the present invention, a new process has been found wherein oil sand tailing muds are flocculated and subsequently filtered using a specific filtering technique.

Filtration could be considered as a useful separation mechanism for flocculated tailing material because of its ease and relatively low energy consumption. However, there are limitations to solid separation by filtration such as the formation of compact filter cakes, totally plugging the filters. This is called the low Tiller point phenomenon. Normally, in pressure cake filtration techniques, it is expected to receive higher filtration rates and cake solid content (so-called solidosity) by increasing the operating pressure. This is indeed true for incompressible and moderately compactable materials. However, for highly compactable materials, such as flocculated, fragile, or very fine particles, the filtration rate and average cake solodisity will reach a maximum plateau at certain values even when pressure continuously increases. The Tiller point is defined as the pressure when filtration rate reaches 90% of its maximum value. For flocculated oil sand tailing muds, low Tiller points are observed. Thus, for flocculated oil sand tailing muds a specific filtration method is required.

In EP0714318 a filter is described for separation of solids and liquids from muds and specifically muds from industrial processing. In order to separate the solids and liquids in the mud, a container is used comprising a filtering bag and a deformable membrane, comparable to fire-hoses, housed in the container. In the container, squeezing of the filtering bag is achieved by enlarging the size of the volume defined by the deformable membrane (i.e. the fire-hose). The filtering bag is provided with elastic means for ensuring elastic expansion when the squeezing phase is completed.

EP1426089 describes a method for filtering liquid manure originating from pigs. The method comprises flocculating the manure and bringing the manure in co-operative connection with a filter, generating a pressure difference over the filter causing a flow of the fluid medium through the filter and a formation of a residue comprising the solid particles on the side of the filter facing the manure, and breaking the residue while the manure is in co-operative connection with said filter. The manure is flocculated before the pressure difference is generated, and a filter having an abhesive surface is applied, the abhesive surface facing the manure.

### SUMMARY OF THE INVENTION

It has now been found that a filtering process such as for example described in EP1426089 can advantageously be used for the dewatering of oil sand tailing muds to produce clear water and a (semi-)solid residue.

Accordingly, the present invention provides a process for dewatering oil sand tailing muds, comprising:

(a) adding a flocculant into oil sand tailing muds and mixing the flocculant and the tailing muds;
(b) filtering the flocculated tailing muds using a dynamic filtration system, wherein in step (b) a pressure difference is applied over the filter and wherein the dynamic filtration system comprises a means for producing a dynamic action by which the filter cake is continuously or intermittently moved, deformed and/or broken, the filter cake being the solidified material that sets on the filter during filtration.

It was furthermore found that, although the oil sand tailing muds as described herein have a different texture than liquid manure originating from pigs, processing with help of a filtering process as claimed herein is still possible with good results. Filtration according to the invention results in a high and stable water flux at relatively low pressure. The solid product material of the presently claimed process may contain as low levels of only 5% of water. These solids can easily be transported and returned to, for example, the environment from which the tar sands originated. In addition, the water of the product stream does not contain solids anymore.

The process according to the invention has a reduced energy consumption compared to the processes according to the prior art and requires less service.

### BRIEF DESCRIPTION OF THE DRAWINGS

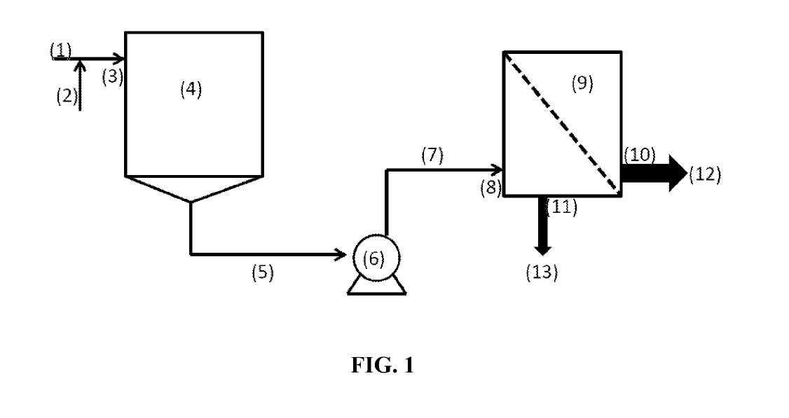

The invention is illustrated by the non-limiting FIG. 1, illustrating an example of a process according to the invention.

### DETAILED DESCRIPTION OF THE INVENTION

The process according to the invention separates water from solids in tailing muds.

Reference herein to oil sand tailing muds is to a slurry of water and fine particles, wherein the particles are in particular selected from particles of sand, clay, minerals and small amounts of residual bitumen. It is noted that the present invention relates to dewatering of oil sand tailing muds, in particular of Mature Fine Tailings (MFT), but it should be understood that the oil sand tailing muds treated according the process of the present invention are not necessarily obtained from a tailing pond. Also other types of muddy water with similar properties may be treated similarly and that is meant to fall within the scope of the definition of “oil sand tailing muds”.

The process of the invention is particularly suitable for dewatering of oil sand tailing muds comprising between 1 to 60%, preferably 5 to 50% and especially 10 to ˜40% of solid materials. The solid materials are sand, clay, silt and some residual bitumen.

According to the present invention, proper flocculation of the oil sand tailing muds is of high importance for successful dewatering. “Proper” flocculation means that the particles are of a certain, most favorable, size.

In an embodiment of the invention, proper flocculation is achieved by selecting a flocculant such that stable flakes having a particle size of 0.1 to 5 mm are formed in the mud. It was found that flakes of this size, which size could for example be established by a microscopic technique or by a sedimentation technique as is well known in the art, are particularly suitable for filtering the tailing mud. That is, high flow rates of water and high separation percentages (amount of water separated from the mud) can this way be provided for. Thus, a further embodiment of the invention is a process for selecting a suitable flocculant for dewatering of oil sand tailing muds, the process comprising adding a flocculant to oil sand tailing muds and determining whether the flakes have a particle size of 0.1 to 5 mm and are stable for at least 4 hours.

In a further embodiment of the invention, before flocculating the mud in step (a) of the process of this invention, a coagulant is added to the said mud, the coagulant preferably, but not necessarily, being a salt of an ion with high valency, such as for instance Fe(III)Cl₃ or AlCl₃. This coagulant is namely non-toxic and can be drained off to the surface water without any harm for the environment. The coagulant is added in order to assist in achieving proper flocculation.

Flocculation reagents are compounds that have structures which form a bridge between particles, uniting the particles into random, three-dimensional aggregated structures or flakes. Some flocculation reagents may be superior to others at commercial scale, depending on many factors. According to the process of the present invention a wide variety of flocculation reagents may be used, by proper mixing and conditioning in accordance with the process steps. By way of example, the “flocculant”, “flocculant reagent” or “flocculation reagent” may be selected from polyethylene oxides, polyacrylamides, anionic and cationic polymers (e.g. polyamide based flocculants like CLX24 and FlowPam available from SNF), polyelectrolytes, starch, co-polymers that may be polyacrylamide-polyacrylate based, commercially available cationic derivatives of acrylic acid (e.g. Stockhausen 852 BC, and SNF Floerger FO 4250), or another type of organic polymer flocculants. The flocculants may be obtained commercially from a flocculant manufacturer and subjected to selection to determine their suitability and indication toward the specific commercial application. Preferably, the flocculant is biodegradable and approved by the US Food and Drug Administration (FDA). A preferred flocculant comprises a starch derived flocculant, used alone or in combination with other (starch derived) flocculants, either as such or dissolved or dispersed in a suitable solvent or solvent mixture. In a preferred embodiment, the flocculant is a starch derived flocculant or a mixture of starch derived flocculants. Further preferred flocculants are anionic and cationic polyamide based flocculants. If used in a solution or dispersion, the solvent preferably comprises water, but may include other solvents as well, as desired. Preferably, the solvents used are environmentally safe, which means that they may be released into the environment without further purification or treatment steps.

The flakes obtained by the flocculation should preferably last at least for the duration of the filtering step. Preferably the flakes obtained by the flocculation have a particle size with a diameter (measured at its largest point) in the range of equal to or more than 100 micrometer.

In an embodiment of the invention a coagulant is added to the tailing muds before the flocculant is added. By a coagulant is understood a substance or mixture of substances that is capable of coagulating (sticking together) in particular colloidal particles, i.e. particles that have a maximum diameter of approximately 1 m. Because of their small size, these particles tend to run through the filter, together with the water and contaminate the filtrate. The coagulant can advantageously be added to make these small particles aggregate to bigger ones which are capable of being flocculated into flakes as described below. In this way a very clean filtrate can be obtained.

Any coagulant known by the skilled person to be suitable for coagulation of sludge or mud can be used. Preferred coagulants include aluminium and iron salts. Examples of further suitable coagulants include, hydrated potassium aluminum sulfate, aluminium chlorohydrate, aluminium sulfate, ferric chloride, ferrous sulfate, ferric sulfate and/or sodium aluminate. Chloride salts of aluminium and iron are most preferred, in particular of iron.

The flocculants and/or coagulants are preferably mixed with the oil sand tailing muds in a mixing unit. This mixing unit may for example comprise a rotor, a stirred mixer or static mixer. Any flocculants and/or coagulants are preferably added to the oil sand tailing muds in a concentration of from equal to or more than 0.001 ppm weight of the tailing muds to equal to or less than 1 wt %, more preferably from equal to or more than 0.01 ppm weight to equal to or less than 0.5 wt %, and further preferred 0.1 ppm weight to 0.05 wt %. Further preferred is the use of 0.1 to 10 kg, preferably 0.5 to 7.5 kg, more preferably 0.5-5 kg of flocculant per tonne of dry matter of the oil sand tailing muds. The flocculation step (time of mixing the flocculant and the tailing muds) preferably takes in the range from equal to more than 10 minutes, however shorter flocculation may also be possible. The flocculation time for anionic and cationic polyamide based flocculants preferably is from about 1 second to 10 minutes, more preferably from 5 seconds to 5 minutes, and particularly preferred from 10 seconds to 2 minutes.

As described above, mixing of the oil sand tailing muds with the flocculant may take place in a separate mixing unit. In a preferred embodiment of the invention, the mixing of the oil sand tailing muds with the flocculant takes place by in-line mixing. In such a set-up a flocculant solution is pumped into the line through which the tailing muds are fed to the filtration unit. The length of the line and the quantity of the tailing muds determine the mixing time, which can be very short. Similarly, if a coagulant is also used, in a further embodiment, the coagulant is mixed with the tailing muds by way of in-line mixing.

If a coagulant is used, such coagulant is preferably used in a weight ratio of coagulant to flocculant in the range from 1000 to 1 (1000:1) to 1 to 1000 (1:1000).

As soon as proper flocculation has been achieved according to the present invention, various commercially available filtration technologies may be applied, provided the filtration technology uses a system which produces, along with pressure on the material to be dewatered, continuous, or at least intermittent, movement of the filter cake that forms while dewatering takes place. Thus, according to the process of the invention, a dynamic filtration system is used, wherein a pressure difference is applied over the filter. A dynamic filtration system is a system using any type of filtration applying a pressure difference over the filter, that is combined with a means producing a dynamic action by which the filter cake is continuously or intermittently moved, deformed and/or broken. The filter cake herein is the solidified material that sets on the filter during filtration. The dynamic action enhances the flow of water through the filter, in order to increase the overall efficiency of the filtering action. The dynamic action may be produced by any means known in the art, for example by movement of membranes below the filter, e.g. by inflation of the membranes, or by vibrations e.g. as used in Vibratory Shear Enhanced Process (VSEP), and the like. Examples of commercially available dynamic filtration systems are the Dynamic Filter Chamber Press, the KM-TEC K1 Peristaltic Filter Press, the dynamic chamber filter press Netsch KFP/MFP 470-470×8/15 bar and the Andritz Membrane Filter Press. Preferred systems include systems wherein a filter cake (or residue) is formed in the dynamic filtration system, which filter cake is broken by a (optional mechanical) deformation of the filter.

A preferred process according to the invention comprises using a membrane filter press. The process comprises an initial phase of filling and filtering, similar to processes for instance known for chamber filter press systems, which comprises filling separate filter chamber cavities which are covered with a permeable filter mesh. The feed pressure ensures the water permeability. Because with filtering tailing muds the filter blocks rapidly (i.e. the water flux across the filter is reduced and finally essentially stopped), according to the invention the use of a dynamic filter press system is required. After reaching a predefined pressure, suitably around 4-10 bar, depending on the tailing mud characteristics, the feeding of the tailing mud is stopped and the membranes are slowly deformed, e.g. by inflation using either a liquid (e.g. water) or a gas (e.g. optionally compressed air) as squeeze medium. The filter cake is hereby compressed and dewatered further. The process is continued until the filtrate flow reaches a preset minimum limit. Then the squeeze medium is relieved and the filter cake discharged. Membrane plates, as used herein, are flexible membranes fixed to a support body. Materials for the membranes suitably include polypropylene, synthetic rubber (e.g. NBR, EPDM), thermoplastic elastomer (TPE) or specialized materials, such as PVDF. The membrane is impermeable and serves to compress the filter cake within the filter chamber after the filtration process is complete.

Preferably the filter is a deformable filter. By a deformable filter is understood a filter that can undergo, preferably mechanical, deformation as described herein. The filter can be deformed by any means known to the skilled person for this purpose. Deformation may occur continuously or intermittently. The deformation may include peristaltic movements, kneading, vibrations, and/or combinations thereof. Preferably the deformation includes peristaltic movements. The, preferably peristaltic, deformation may conveniently be brought about by using air filled fire hoses and/or mechanical rolls. Preferred manners of deformation are described in EP0714318 and EP1426089.

The filter can be made from a variety of fabrics. Preferred fabrics are woven fabrics. Examples of suitable fabrics include polyamides (such as for example nylon), polyaramides (such as for example Kevlar), polypropylene, polyethylene, polyester, PET, Teflon-type polymers (such as for example PTFE and/or polytetrafluorethylene), cotton and/or mixtures thereof.

Preferably the filter is a filter having an abhesive surface, the abhesive surface facing the mixture, as described for example in EP1426089 and herein incorporated by reference. By an abhesive surface is herein understood that the surface is capable of preventing or reducing adhesion to its surface, that is upon an impact the residue that adheres to the filter substantially comes off.

Any filter material known by the skilled person in the art to have such an abhesive surface can be used. Preferably the filter comprises an abhesive filtering fabric, such as fabrics made from materials that are known for reducing adhesion such as polymers containing a high fluorine content. It is preferred that the filter has a calendared surface. By calendaring the surface of the filter, sharp edges, bulges, irregularities etc. of this surface are substantially removed. The surface of the filter becomes more or less flat so that there are hardly any sites for the residue to mechanically adhere. Thus, by calendaring the surface of a filter, this surface can be made more abhesive.

In an embodiment the filter comprises a first filtering fabric that is calendared and a second supporting fabric for supporting this first filtering fabric. By providing a first filtering fabric and a second supporting fabric, good filtering properties could be provided for by the first filtering fabric (preferably made out of thin fibres and having a small mesh size) and good mechanical strength could be provided for by the second supporting fabric (preferably made out of thick wires and having a large mesh size in order to be strong but not block the filter).

Preferably the filter (or if two filtering fabrics are present the first filtering fabric) comprises a mesh size ranging from equal to or more than 5 m, more preferably from equal to or more than 10 m, to equal to or less than 1000 m, more preferably to equal to or less than 200 m, and most preferably equal to or less than 100 m.

For example, the mesh size may be such that a particle having a diameter of equal to or more than 1000 m, more preferably of equal to or more than 200 m, most preferably equal to or more than 100 m will be retained by the filter.

The filter may have any shape known by the skilled person to be suitable for this purpose. For example the filter may be shaped as an essentially vertically arranged tube. Preferably, however, the filter is shaped as an essentially horizontally arranged belt or as an essentially horizontally arranged tube.

The process can be carried out in a batch, semi-batch or continuous manner. In a preferred embodiment the process, in particular step b), is carried out in a continuous manner.

In an embodiment of the invention the flocculated tailing muds are filtered with the filtrate flowing in an essentially vertical direction. That is, the filter is situated essentially horizontally, with gravitational forces assisting in the filtration and the retrieval of the filtrate.

Step b) can be carried out in a continuous manner by a system of multiple horizontally and/or vertically arranged filters which are used in an alternating manner. In such a system, advantageously one or more filter(s) may be in use to filter the mixture, whereas one or more other filter(s) may be filled up, emptied or cleaned.

The above described continuous modes of operation have the advantage that the process is easy to scale up, a very important requirement for commercial processes for dewatering of tailing muds.

In the process according to the invention in step b) a pressure difference is applied over the filter. This pressure difference may assist in causing a flow of water through the filter and formation of the filter residue on the side of the filter facing the flocculated mixture. A wide range of pressures can be applied. Preferably a pressure difference in the range from equal to or more than 0.1 bar, more preferably equal to or more than 1 bar; to equal to or less than 15 bar, more preferably equal to or less than 10 bar, is applied. Conveniently the mixture may be pressurized with a plunger pump that is capable of pressurizing the mixture without exerting too much mechanical forces on the mixture.

In step b) of the process according to the invention the mixture is filtered by means of a dynamic filtration system to form a filtrate (water) essentially without solids and a solid filter residue containing at least 70% of solids, and preferably less than 15%, more preferred less than 10%, even more preferred less than 5% of residual water. A “filtrate essentially without solids” herein means that no solids can be observed visually in the filtrate. The water filtrate may be further treated using traditional water treating methods, such as a bio-treater.

The filter residue may optionally be further dried before any subsequent processing. Preferably drying comprises one or more solar drying steps and/or one or more forced air flow drying steps. Solar drying may suitably comprise heating the filter residue by solar energy, optionally in a glass construction.

An example of the process according to the invention is illustrated by non-limiting FIG. 1.

In FIG. 1 a feed of oil sand tailing muds (e.g. MFT) is supplied through a line (1) via inlet (3) into a mixing unit (4) equipped with a rotor or other mixing device. A solution or dispersion of flocculant(s) is added to the tailing muds into the mixing unit (4) via inlet (3) either through line (1) or through a separate line (2) which feeds into line (1), and the mixture is allowed to flocculate. If applicable, a solution or dispersion of coagulant(s) may be introduced similar to the flocculant to the mixing unit together with the flocculant or before the flocculant is introduced. After sufficient flocculation time, the contents of mixing unit (4) is pumped through line (5) to a pump (6), which may be any suitable pump (e.g. a positive displacement pump or a centrifugal pump), and pumped through line (7) via inlet (8) into the dynamic filtration unit (9). Subsequently, filtration starts to produce a filtrate (12) and a filter residue. The filtrate (water) leaves the filtration unit via outlet (10). In the dynamic filtration process, the filter residue is being broken and moved in the dynamic filtration unit until most of the water in the tailing muds has been separated from the solids. Then the solid filter residue (13) is removed from the filtration unit via discharge exit (11).

The invention is further illustrated by the following non-limiting examples.

### Example 1

Tests were performed with Mature Fine Tailings (MFT) that originate from the water based extraction process of bitumen in the Athabasca oil sands project. Next to the objected bitumen, this process produces a water stream containing sand and clay particles. Due to the presence of very fine clay particles, settling requires very long waiting times. This process stream is currently being led to tailing ponds. In these ponds, the Mature Fine Tailings form a non-settling layer.

The material used in the current test had a solid content of approximately 40% and consists next to water of clay, sand and residual bitumen. The amount of bitumen was around 0.5% max.

The line-up for this experiment is shown in FIG. 1. In total a 150 kg MFT was made available as a feed in the experiment and was fed through line (1) into the mixing unit (4). About 50 gram of a starch based flocculant was dissolved in about 10 litres of water. This solution was added through line (2) via inlet (3) under stirring to the MFT in the mixing unit (4). Stirring was continued for about 10 minutes and then the mixture was pumped by pump (6) to the dynamic filtration system (9) in about 5 minutes.

The filter system in this line-up consisted of a dynamic system, allowing for a continuously breaking of the filter cake). Tests were performed with the Dynamic Filter Chamber Press (50 kg scale) and the KM-TEC K1 Peristaltic Filter Press (100 kg scale).

Filtration was performed relative fast and took about 10 minutes. A clear water filtrate and a solid filter cake were obtained. The filter cake proved to be >95% solids and was hard to break. The water was analysed visually and proved to be free of solid particles.

### Example 2

In a typical experiment, a solution of a suitable water soluble polymeric flocculant is made, e.g. from stirring 4 g of KM-floc powder (commercially available from Breustedt Chemie) in 1 L water, and maturing for about 1 h. 1 liter of MFT is then mixed with an additive, e.g. 1 mL of Digifloc 50 (commercially available from Breustedt Chemie), and subsequently with an amount of the (e.g. 120 mL of the KM-floc) polymeric solution. The MFT mixture is mixed until “free” water is visible. Then the mixture can be transferred to the dynamic filtration press system, such as the Dynamic Filter Chamber Press and the KM-TEC K1 Peristaltic Filter Press. The process can also be performed without using additive, but then more of the polymeric solution (in the above example about 20 mL) is needed for obtaining stable flocculated materials.

### Example 3

In a typical experiment, 43.2 Kg of Mature Fine Tailings with a solid content of approximately 41% was mixed properly with 29 L of a 0.3 wt % solutions of CLX24 (cationic polyamide based flocculant, commercially available from SNF), i.e. 5 kg flocculant per tonne dry filter matter. Flocculation was achieved within 10-30 seconds. After flocculation, part of the mixture was fed into 2 chambers of the dynamic chamber filter press (Netsch KFP/MFP 470-470×8/15 bar, commercially available from Andritz; 2 plate filter—chamber thickness 35 mm, chamber volume 7 dm³, membrane plates type Lenzer/Klinkau 470×470). First, the mixture was dewatered in an initial dewatering phase; a pressure of approximately 5 bars was maintained during this dewatering phase (about 10 minutes). Thereafter, dynamic filtration was started to further dewater the filter cake (again about 10 minutes). The procedure was repeated with the remainder of the flocculated material. The total water produced amounted for 19.5 L and appeared to be virtually hydrocarbon free and free of solid particles. After opening of the press, 2 filter cakes readily released from the filter cloths (combined mass of 22.6 kg). The cloths appeared to be clean and could be used for a next pressing without further cleaning. The solid content of the filter cake was >70% (76%). In subsequent tests, flocculant use was reduced to 3.5 kg/tonne dry matter.

In similar experiments, MFT with solid contents of respectively 10 or 20% were tested. The amount of flocculant used was adjusted to the solid content (ranging from 5 to 1 kg per tonne). Results on water (TOC levels) and filter cake (solid contents) were identical.

### Example 4

In another experiment, 52.6 Kg of Mature Fine Tailings with a solid content of approximately 36% was mixed properly with 6.3 of a 0.3 wt % solutions of FlowPam A-3338 (anionic polyamide based flocculant, commercially available from SNF), i.e. 1 kg flocculant per tonne dry filter matter. Flocculation was achieved within 10-30 seconds. After flocculation, a part of the mixture was fed into 2 chambers of the dynamic chamber filter press (see Example 3). First, the mixture was dewatered in an initial dewatering phase; a pressure of approximately 5 bars was maintained during the dewatering phase (about 10 minutes). Thereafter, dynamic filtration was started to further dewater the filter cake (again about 10 minutes). The procedure was repeated with the remainder of the flocculated material. The water produced amounted for 25.2 L and appeared to contain some oily material. After opening of the press, 2 filter cakes readily released from the filter cloths (combined mass of 25.1 kg). The cloths appeared to be virtually clean and were rinsed with water before the next pressing. The solid content of the filter cake was >74%.

The data of Examples 3 and 4 are summarized in Table 1.

TABLE 1

Flocculants used

| | CLX24 (Ex. 3) | Flow Pam (Ex. 4) |
|---|---|---|
| Intake | 43.2 kg | 52.6 kg |
| % MFT | 41% | 36% |
| Filtrate | 19.5 Kg | 25.2 Kg |
| Cake | 22.6 kg | 25.1 Kg |
| % solids cake | 76% | 74% |
| Solids in cake | 17.2 kg | 18.5 Kg |
| Mass balance | 96% | 95% |
| Remarks | Cake released well | Cake releases well |
| | Water appears clear | Bitumen on the cloth |
| | | Oily water |

### Water Analyses:

The water obtained in Examples 3 and 4 was analysed for ionic contaminants by ICP-MS. Results are depicted in Table 2 below. The Calcium and Magnesium content of the feed amounts for respectively 45 ppm and 20 ppm. The total organic content (TOC) was determined according to APHA 5310A.

TABLE 2
Water analysis

| | CLX24 (Ex. 3) | FlowPam (Ex. 4) |
|---|---|---|
| Al, mg/kg | <0.1 | <0.1 |
| Ca, mg/kg | 39.3 +/− 2.0 | 21.8 +/− 1.1 |
| Fe, mg/kg | <0.1 | <0.1 |
| K, mg/kg | 21.1 +/− 1.1 | 18.1 +/− 0.9 |
| Mg, mg/kg | 21.7 +/− 1.1 | 10.6 +/− 0.5 |
| Na, mg/kg | 388 +/− 19 | 359 +/− 18 |
| TOC (Total organic | 60 mg/L | varies between 3000-7000 mg/L |
| Content) | | |
| toxicity | no acute toxicity | no acute toxicity |

### Filter Cake Analyses:

The filter cakes were subjected to Soxhlet extraction with toluene.

Approximately 85 g of filter cake material from Example 3 (obtained using a CLX 24 flocculant) was extracted for 24 hours with toluene. Thereafter, the solvent was removed via evaporation and the amount of residual oil that was extracted from the cake was determined. About 7.9 gram of oils was obtained from the filter cake (9.3% by mass).

In another experiment 71 g of filter cake material from Example 4 (obtained with a anionic flocculant FlowPam) was extracted with toluene for 24 hours. Thereafter, the solvent was removed via evaporation and the amount of residual oil that was extracted from the cake was determined. In this case, 4.7 gram of oil was extracted (6.6% by mass).

That which is claimed is:

1. A process for dewatering oil sand tailing muds, comprising:
(a) adding a flocculant into oil sand tailing muds and mixing the flocculant and the tailing muds;
(b) filtering the flocculated tailing muds using a dynamic filtration system, wherein in step (b) a pressure difference is applied over the filter and wherein the dynamic filtration system comprises a means for producing a dynamic action by which the filter cake is continuously or intermittently moved, deformed and/or broken, the filter cake being the solidified material that sets on the filter during filtration.

2. The process of claim 1, wherein the tailing muds comprise between 1 to 60% solid materials.

3. The process of claim 1, wherein the flocculant comprises a biodegradable flocculant.

4. The process of claim 1, wherein the flocculant comprises a starch derived flocculant.

5. The process of claim 1, wherein the flocculant is an anionic or cationic polyamide based flocculant.

6. The process of claim 1, wherein the flocculants are added to the tailing muds in a concentration of from equal to or more than 0.001 ppm weight to equal to or less than 1 wt %.

7. The process of claim 1, wherein the mixing of the tailing muds with the flocculant takes place by in-line mixing.

8. The process according to claim 1, wherein a filter cake is formed in the dynamic filtration system, which filter cake is broken by a deformation of the filter.

9. The process according to claim 1, wherein the tailing muds are Mature Fine Tailings (MFT).
